(19) United States
(12) Patent Application Publication
(10) Pub. No.: US 2003/0227776 A1
(43) Pub. Date: Dec. 11, 2003

(54) LINEAR SUSPENSION PROJECTOR LAMP ASSEMBLY

(76) Inventor: Michael Lin, Taipei Hsien (TW)

Correspondence Address: CHADBOURNE & PARKE LLP, 30 Rockefeller Plaza, New York,, NY, 10112, US

(21) Appl. No.: 10/164,001

(22) Filed: Jun. 7, 2002

(51) Int. Cl. F21V 21/18

(52) U.S. Cl. 362/402; 362/403; 362/404; 362/407

(57) ABSTRACT

A linear suspension projector lamp assembly, comprising an upper rack providing a space for electrical connection and winding; a lower rack having an electrical box for assembly of lighting fixtures and lighting accessories, on two sides of an arm rod being provided for a cord end of the cord to fasten and tie on, a counterweight unit, installed between the racks, for insertion and assembly by two cord ends for respective tying purposes, and provides a work space for assembling of a locator, the locator can be operated single-handedly to fasten or loosen the cord, to adjust a lighting height position and obtain better positioning and stabilizing effects, to carry a larger or a heavier lighting fixture, meanwhile, by assembling various types of racks and counterweight unit, in combination or in replacement of all types of lighting fixtures and lighting accessories, to compose various types of linear suspension projector lamp assembly for consumer's optional purchase.

### BACKGROUND OF THE INVENTION

The projector lamps available on the market are assembled to include an extension rod at an end of the lamp fixture and the lamp hood, at the end of the extension rod is installed a connector to match a track for fastening and positioning purposes or for assembling and positioning a power source supply box, the height of the assembled lighting fixture is fixed, since the length of the extension rod is a known constant that could not be adjusted to suit the user's requirement at any time to produce different luminosity and change of brightness.

Therefore, manufacturers have designed different projector lamps with adjustable lighting height of the lighting fixture, as shown in FIG. 1, the projector lamp is connected by a cord to a power supply box, and at a position next to the power supply box is installed a roller rack for the cord to wind thereon and for the roller rack to be positioned between the projector lamp and the power supply box, and at the cord section between the power supply box and the roller rack is movably installed a counterweight unit, by means of the rollers on the roller rack and the counterweight unit, the linearly configured projector lamp can have its lighting height adjusted at any time by moving the counterweight unit on the cord and change of its hanging height; but in this kind of construction, there must be a balance between the projector lamp and the counterweight, under this condition, the types and specifications of the projector lamp that can be used are quite limited, or require a larger or heavier projector lamp assembly to increase the weight and cubic measurements of the counterweight, but if the cubic measurements of the counterweight is too large, it will influence the integral appearance and cause difficulty in applications, and in consideration of security factors, this type of construction and linear suspension assembly can only be applicable to low-voltage projector lamps, which is also a shortcoming due to limitation on the range of applications.

There are different projector lamps with ready adjustment of lighting height as disclosed in Taiwan Utility Model Patents No. 142114 and 141626 and U.S. Pat. No. 5,440,469, wherein:

Taiwan Utility Model Patents Nos. 142114 and 141626 disclose a linear controlled type of suspension lamp assembly and transmission power source, meanwhile, a projector lamp construction with high or low position adjustable according to length change with a cord with counterweight has adopted a positioning box unit, in the unit is installed an insulation base unit to install conductive blocks, respectively corresponding to a transformer output end for electrical conductivity, then two conductive blocks are provided for direct winding of conductive cord, or assembled with a cord rod to wind the conductive wire, one end of two wires is fixed to a counterweight, while the other end is inserted in the counterweight unit before it is connected to one of two connecting rod of the lamp, forming a longitudinal suspension assembly of the lamp and counterweight unit, and assembly of the cord in direct connection, and due to the winding and connection of the cord, the interval between the lamp and the counterweight can be changed to adjust the height of the lamp. In such a structural configuration, there must be the existence of a specified counterweight balance between the projector lamp and the counterweight, under such conditions, the types and specifications of projector lamp for use are quite limited, or require larger or heavier projector lamps to increase the weight and cubic measurements of the counterweight, but if the cubic measurements of the counterweight is too large, it will influence the integral appearance of the lamp and result in difficulty in applications, and in consideration of security factors, such construction and linear suspension assembly can only be applied to low-voltage projector lamps, which is a shortcoming of restricted scope of application.

Disclosed by U.S. Pat. No. 5,440,469 is a vertical rod type projector lamp structure, two vertical rods are used for connection with a power source, with extended length of the two vertical rods for adjustment and movement of the projector lamp and requirement of long distance, and t the projector lamp and the vertical rod is connected by screws on two sides of the electrical chamber of the projector lamp, and are secured in position by tightening the screws when the vertical rods are moved to the desired positions; though this structural design does not involve the problem of compatible assembly of the projector lamp and the counterweight, in actual adjustment of their positions, you have to loosen the screws one by one before tightening them one by one, if the height must be adjusted during use, it will involve more trouble, because the operating temperature of the halogen lamp used in the projector lamp is quite high, in loosening, dislocating and retightening processes for adjustment of this structure, a lighting unit must be carried to perform the operation, so the operation becomes more difficult; and, in adjusting the projector lamp to a higher position, due to limitations of the projector lamp assembly that could not match the vertical rod in penetrated assembly, there will be the shortcoming of dislocation when the lamp hood or lamp decoration of the projector lamp pressing against the two vertical rods, so the projector lamp assembly creates an angle deviation, or to avoid the two vertical rods and requires to limit the types and specifications and cubic measures of the lighting fixture to using assembling components in the range of the two vertical rods, which will cause the difficulty of limiting the range of applicable components.

### SUMMARY OF THE INVENTION

The present invention of linear suspension projector lamp assembly comprises an upper rack, providing a space for electrical connection and cord winding, so after winding the cord extends downward to form two cord ends; a lower rack, having an electrical box to assemble the lighting fixture and lighting accessories, on two sides of an arm rod are provided for tying purpose to a cord end, a counterweight unit, installed between the two racks, for the two ends to respectively tie and assemble, and a work chamber space to assemble a locator, by single hand operation to control the locator to fasten or loosen the cord, thereby adjusting a lighting height and obtain better positioning and stabilizing effects, to carry a larger or heavier lighting assembly, meanwhile, by means of assembly of various types of racks and counterweight units, in combination with the installation or replacement of various types of lighting fixtures and lighting accessories, to compose various types of linear suspension projector lamps for consumer's optional purchase.

### BRIEF DESCRIPTION OF DRAWINGS

FIG. 1 is a schematic view of prior art of linear suspension projector lamp.

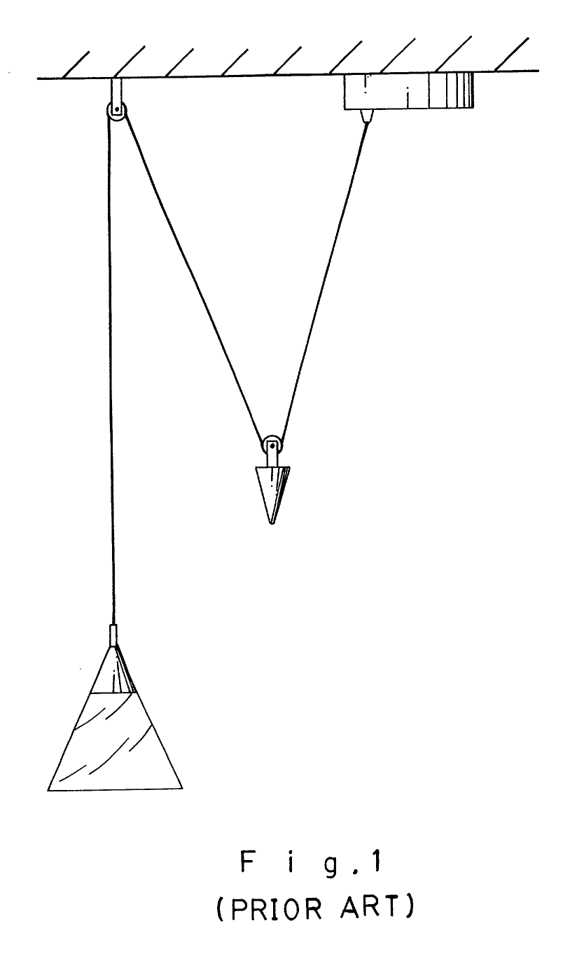

FIG. 2 is an exploded view of the embodiment of the present invention applicable to 12V low-voltage projector lamp assembly.

FIG. 3 is a perspective view of the assembled embodiment of the invention in FIG. 2 and how the locator is fastening the cord.

FIG. 4 is a sectional assembled view of the embodiment in FIG. 2.

FIG. 5 is a section view of the invention of locator disengaging its fastening on the cord.

FIG. 6 is a section view of the embodiment of the invention in FIG. 2 after adjustment of its lighting height.

FIG. 7 is an exploded view of the embodiment of the invention applied to 230V higher-voltage projector lamp assembly.

FIG. 8 is a perspective view of the assembled embodiment of the invention in FIG. 7.

FIG. 9 is a section view of the embodiment of the invention in FIG. 7 after adjustment of a lighting height.

### DETAILED DESCRIPTION OF PREFERRED EMBODIMENTS

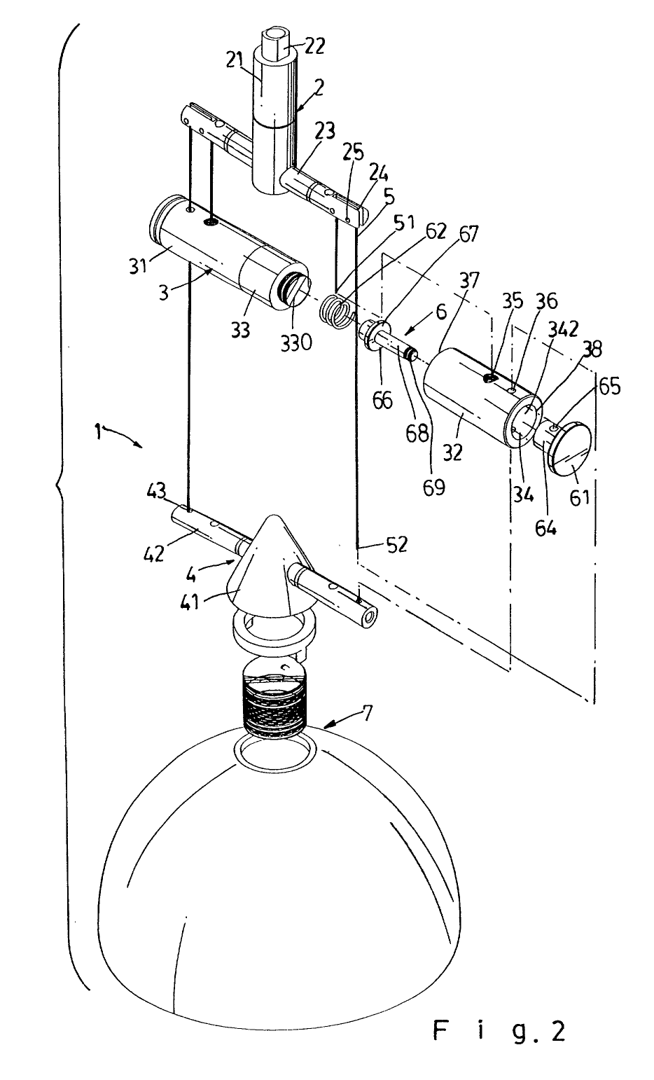

FIGS. 2 through 4 illustrate an embodiment of the present invention of linear suspension projector lamp, with a 12V low-voltage power source directly supplied from a suspension cord. In the drawing, the present invention of linear suspension assembly device 1 comprises an upper rack 2, a counterweight unit 3 and a lower rack 4 in sequential arrangement, with at least a cord 5 intertwining the upper rack 2, the counterweight unit 3 and the lower rack 4 at adjustable intervals from each other, and a locator 6 installed between the lower rack 4 and the cord 5 for control of respective positions, so a projector lamp assembly 7 and the counterweight unit 3 can be assembled to each other even under an unbalanced counterweight environment, and the counterweight unit 3 and the locator 6 can be loosened or fastened single-handedly for free and easy adjustment of a height and position for projected lighting, meanwhile, all lighting fixtures and lamp decorative accessories can be optionally selected for variable assemblies of different types of projector lamp assembly 7, as shown in FIG. 2, wherein:

The upper rack 2 comprises a longitudinally assembled extension rod 21, on an upper end 22 thereof can be installed various types of electrical connectors to correspond to the track for electrical connection, or directly correspond to the power supply box for electrical connection, such electrical connection is a regular general electrical assembly structure, therefore it needs no elaboration and illustration by drawings, on the other end of the extension rod 21 is a horizontally installed lock shaft rod 23, on two sides of the rod 23 are respectively provided a longitudinally arranged winding space 24, in the space 24 is installed a shaft post 25 in horizontal arrangement, serving as a winding rack with the function of a fulcrum for suspension for the cord 5;

The lock shaft rod 23 is preferably made of a metal material with electrical conductivity, for electrical connection with the power supply box, so the connected power source can be transmitted to the cord 5 by direct electrical connection; there is an angle formed in the assembly of the lock shaft rod 23 and the extension rod 21, this assembly angle can be variably adopted according to design, and preferably the lock shaft rod 23 is in horizontal angle extension, but not limited to this assembly angle; likewise, the extension shape and length of the lock shaft rod 23 can be selectively adopted depending on different designs.

At least one cord 5, directly wound inside the winding rack space 24 of the upper rack 2, the ends of two sides of the cord 5 and the ends of the first and second cords 51, 52 are respectively extended downward to correspond to the counterweight unit 3 and the lower rack 4 as connection; better suspension symmetry and balance are obtained in the preferred embodiment of the present invention, with the adoption of two cords 5 assembled for use for description purpose, this is a preferred symmetrical and balanced suspension configuration, and this cord 5 is preferably made of a conductive metal material, as for the wire diameter and length, they will be determined to suit requirements as designed.

The lower rack 4 comprises an electrical box 41, extending to two sides are respectively the extension of an arm rod 42, on two sides of the arm rod 42 is provided a joining hole 43, to be fixed and fastened by an end of a second cord 52 of the cord 5 after penetrating the counterweight unit 3; the two arm rods 42 are preferably made of conductive metal material, so it is connected with the cord 5 as introduction of power source, then it is extended to one end inside the electrical box 41 and in electrical connection with the lamp holder for power supply; and, there is an angle formed between the assembled arm rod 42 and the electrical box 41, this assembled angle can be variably adopted according to design, and preferably the arm rod 42 is in horizontal angle extension, but not limited to this assembled angle, likewise, the extended shape and length of the arm rod 42 can be selected for adoption depending on different designs.

The electrical box 41 used by the lower rack 4 can be an electrical box 41 in various styles and configurations, inside the electrical box 41 is directly installed a lamp holder to install the projector lamp (such as halogen lamp or other types of lamp), and the assembly can be replaced or not assembled with various types of lamp fixtures to suit the requirements, such as lamp hood, reflective hood, and various types of lighting fixtures, to configure different styles and types of projector lamp assembly 7, even if a larger or heavier lamp assembly can be assembled for use; of course, this electrical box 41 can also be directly assembled integrally with the lighting fixture and lamp hood, for the purpose of installing a lamp holder, a reflective hood or other lighting fixtures, and of replacing of various types of lighting fixtures, to assemble different styles and types of projector lamp assembly 7.

The counterweight unit 3 installed between the upper and lower racks 2, 4 consists of two cylinders 31, 32 in combination with an insulation unit 33, and can be formed in different shapes, the hollow space inside the two cylinders 31, 32, matches a first opening 37 and a second opening 38 in symmetrical arrangement to the cylinders 331, 32, to assemble a work chamber 34. This work chamber 34 is divided by a partition wall 340, forming a flexibility chamber 341 assembled to an end face 330 beside an insulation unit 33, and a cord control chamber 342 located on the outer side and corresponding to a second opening 38, this flexibility chamber 341 and the cord control chamber 342 are joined to communicate with each other by way of a channel 343 opened on the partition wall 340, to enable assembly of the locator 6 and room for locating operation by fastening or loosening of the cord 5, and the press member 61 of the locator 6 is extended outwardly from the second opening 38 of the cylinders 31, 32; on the two cylinders 31, 32 are respectively at least a tying hole 35 which is to be tied directly to the counterweight unit 3 by the first cord end 51 after it is extended, and at least a through hole 36 that runs through the cord control chamber 342 of the work chamber 34 to correspond to the locator 6, so the second cord end 52 of the cord 5 runs through it and extends downward to tie on the lower rack 4.

At least one set of locators 6, in this embodiment there are two sets of locators that are symmetrically arranged and respectively installed in the work chamber 34 of the cylinders 31, 32, so simultaneous control can be made single-handedly to press, the locator 6 comprises a press member 61, movably assembled in the cord control chamber 342 of the work chamber 34, for direct control of the cord 5 for engaging or loosening operation, this press member 61 has an extension of a lock assembly nozzle 64 with an inside screw thread, running axially through the end face of the lock assembly nozzle 64 is a cord pulling hole 65, serving to be penetrated for assembly by the second cord end 52 of the cord 5; a press key 66 movably assembled inside the flexibility chamber 341 of the work chamber 34, having a press shaft wall 67, forming a press space between the wall 67 and a side face 330 of the insulation unit 33, with the installation of a flexibility member 62 that regularly presses the press key 67 toward the wall 340, the press key 66 has a connecting key 68 extended from an end face of the press shaft wall 67, which in regular conditions penetrate a channel 343 on the wall 340, and tightened by the thread 69 inside the cord control chamber 342 corresponding to the lock assembly nozzle 64 of the press member 61, the press member 61 in normal conditions is protruded from the work chamber 34 and the second opening 52 and installed at an interval, this is the room for control operation by the press member 61 to the cord 5.

The outer diameter of the lock assembly nozzle 65 of the press member 61 is slightly smaller than the inside diameter of the cord control chamber 342, this diameter difference is equal to or no larger than the diameter of the cord 5 adopted; meanwhile, the cord pulling hole 65 on the lock assembly nozzle 65 and the through hole 36 of the through cord control chamber 342 are opened in a same longitudinal direction, and when the press member 61 is pressed and dislocated toward the cord control chamber 342, the cord pulling hole 65 of the lock assembly nozzle 64 and the through hole 36 of the cord control chamber 342 are opposite to each other, at this time, the cord 5 is not yet fastened, in other words, the cord 5 is fastened into position in a way that the cord 5 runs through the cord pulling hole 65 of the lock assembly nozzle 64 and the through hole 36 of the cord control chamber 342, using the interval between the cord pulling hole 65 and the through hole 36 and the diameter difference between the lock assembly nozzle 64 and the cord control chamber 342, forming the cord 5 being fastened in position; and in the press shaft wall 67 of the press key 66, the outside diameter of the end face of the wall 67 is slightly larger than the inside diameter of the channel 343 of the wall 340, forming a flexibility stopping function in normal position toward the press key 66.

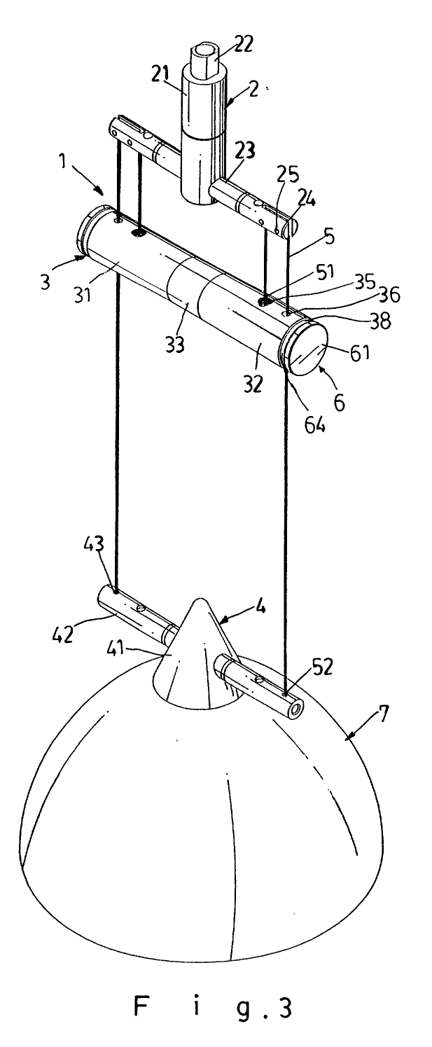

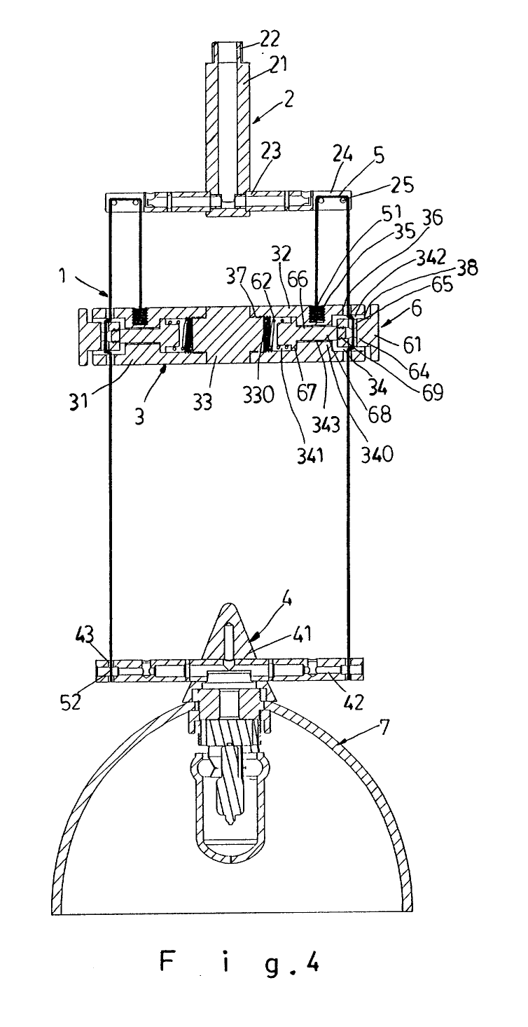

FIGS. 3 through 6 illustrate how the embodiment of the invention is actually assembled and how the lighting height and position are adjusted and positioned. This embodiment is applicable to 12V low voltage projector lamp assembly, the cord 5 for direct power transmission, or, this cord 5 is wound directly in the winding rack space 24 provided by the lock shaft rod 23 of the upper rack 2, the first cord end 51 of the cord 5 extended to correspond to the tying hole 35 of the counterweight unit 3 to be tied and fixed, the second cord end 52 of the cord 5 is similarly extended to penetrate the work chamber 34 of the counterweight unit 3 and the locator 6 assembly before it is extended downward and tied to the lower rack 4, while the lower rack 4 is fixed and assembled to selected lighting fixtures and lighting decorative accessories, comprising a linear suspension projector lamp assembly 7, as shown in FIGS. 3 and 4;

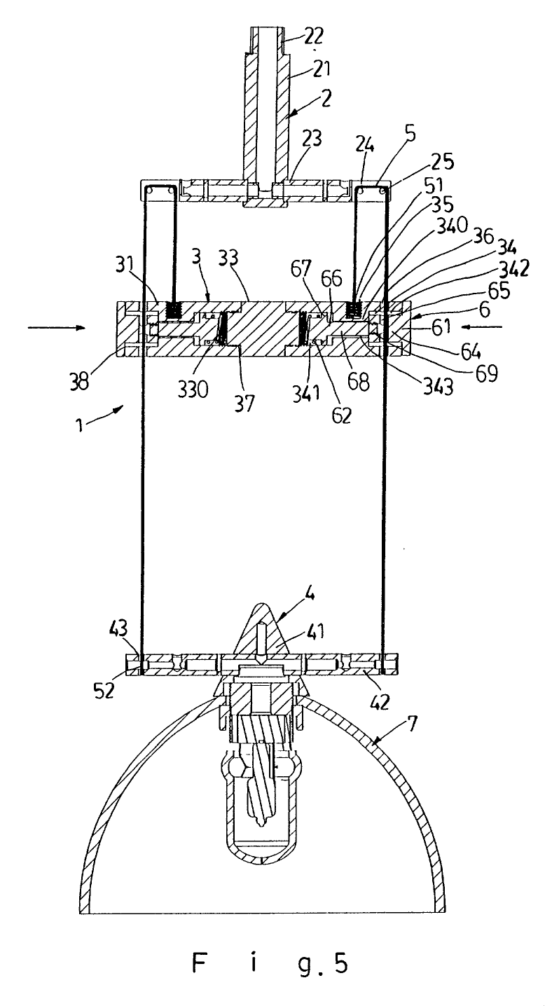

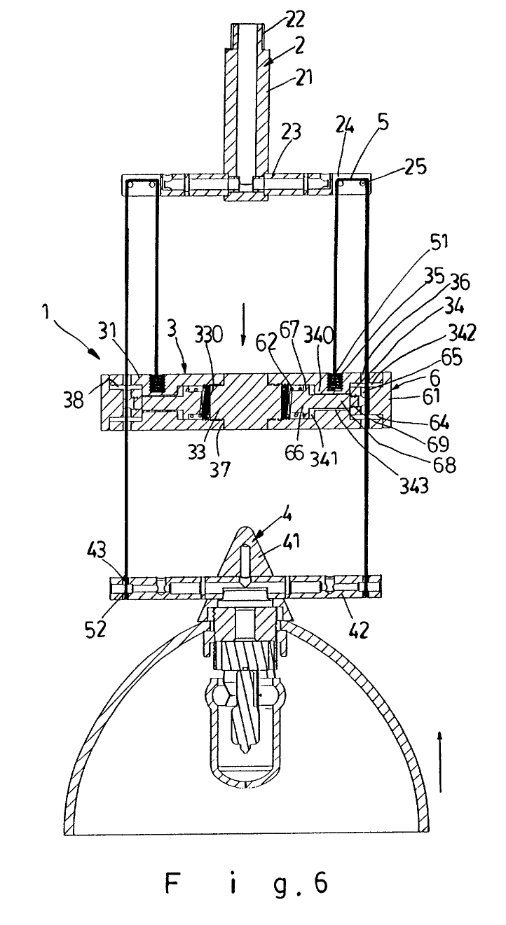

As for the actual operation of the adjustment of the lighting height and position, please refer to FIGS. 3 to 6, when the user wishes to adjust the lighting height of the projector lamp assembly 7 (shown in FIGS. 3 and 4) that has been in position, the time for the adjustment can be during the use of the lamp or after an extended period of use when the lamp is operating at a high temperature, or when it is not used, the user can at any time make adjustment to suit requirements, in the adjusting operation, the user can operate single-handedly, by using his two fingers in one hand, that are facing each other, to apply force simultaneously on the press member 61 of the locator 6, so the press member 61 is moved in the cylinders 31, 32 and the work chamber 34, driving the cord pulling hole 65 on the lock assembly nozzle 64 to match the through hole 36 of the cord control chamber 342, thereby disengaging its fastening on the cord 5 (shown in FIG. 5), so the cord 5 and the counterweight unit 3 are capable of movement, meanwhile, the counterweight unit 3 is moved up or down, at this time, since the two cord ends 51, 52 of the cord 3 are respectively tied to the counterweight unit 3 and the lower rack 4, so the counterweight unit 3 is moved up or down, and by the transmission of the cord 5, is dislocated in relation to the projector lamp assembly, in other words, the counterweight unit 3 moves up, the projector lamp assembly 7 moves down, likewise when the counterweight unit 3 moves down, the projector lamp assembly 7 moves up (shown in FIG. 6), and when adjusted to desired position, the user needs only move away the force applied by his single hand, then the press member 61 of the locator 6 will be reset due to the flexibility of the flexibility member 62, at this time, the a displaced clearance is produced between the cord pulling hole 65 and the through hole 35 because of the resetting of the press member 61, causing the cord 5 to be pulled slightly and fastened in the diameter difference between the lock assembly nozzle 64 and the cord control chamber 342, fastening the cord 5 in position (shown in FIG. 4) and because of second fastening of the cord 5 into position, the lighting height and position can be adjusted by simple control, as shown in FIG. 6.

The linear suspension projector lamp assembly consisting of the above structures and its control and operation can be easily conducted by single hand to fasten or loosen control of the locator 6 on the cord 5, pulling the counterweight unit 3 to move and complete the adjustment of the lighting height position, meanwhile, by means of the fastening and positioning function of the locator 6, a better positioning and fixing effect can be obtains, so that the assembly can be selected and the selective range of lighting fixtures is increased with a larger load or a heavier lamp set even when the counterweight unit 3 and the counterweight of the selection of lighting fixtures are not in balance, meanwhile, by means of various combinations of upper and lower racks 2, 4 and the counterweight unit 3, various lighting fixtures can be assembled or replaced, to assemble various types of linear suspension projector lamps for the consumers' option.

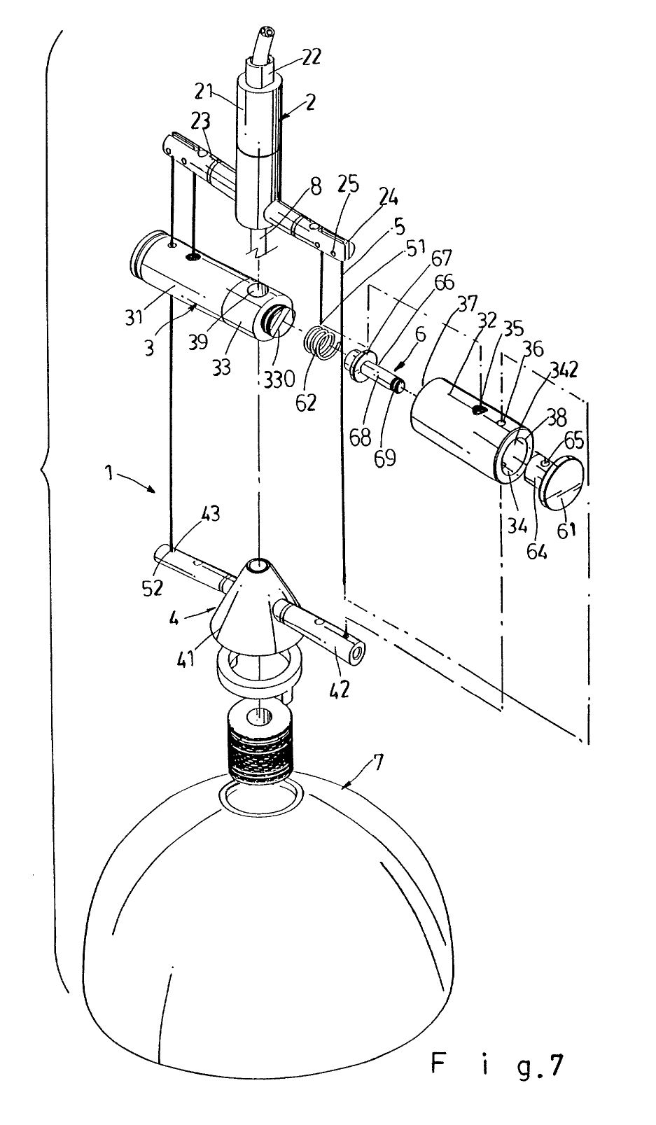

The structural content of the present invention can also be modified for application within the spirit and range of design, please refer to FIG. 7, which illustrates another embodiment of the invention, which is applicable to 230V or higher voltage linear suspension projector lamp assembly, its basic construction is the same as the structure of low-voltage lighting fixtures, the only difference lies mainly in their structures, in consideration of the user's safety, the cord 5 can not be used directly as a power supply, therefore, the extension rod 21 of the upper rack 2 is in the form of a hollow, so the power cord 8 connected to the electric connector or electric power box can be extended directly out of the bottom opening 26 of the extension rod 21, to connect with the lighting fixture and lamp holder installed below the lower rack 4 to supply required power source.

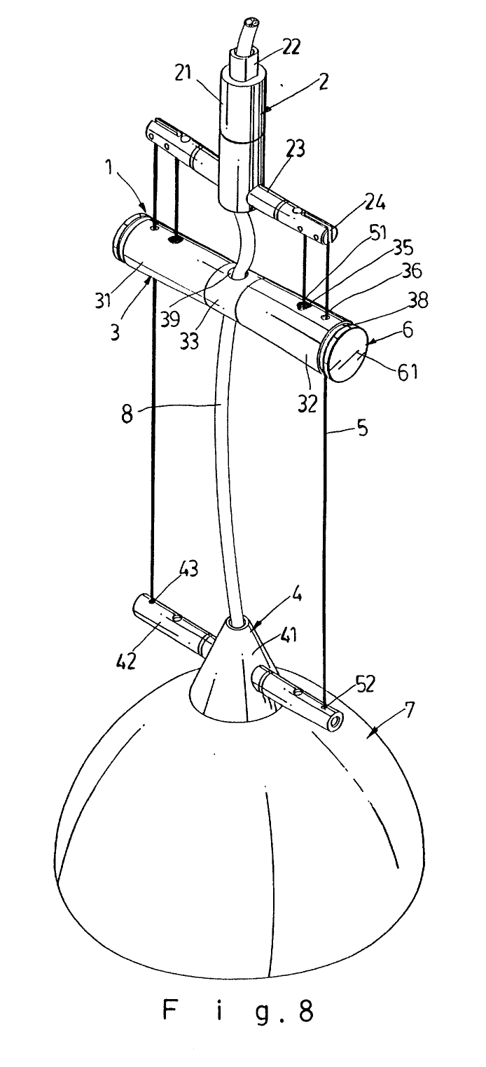

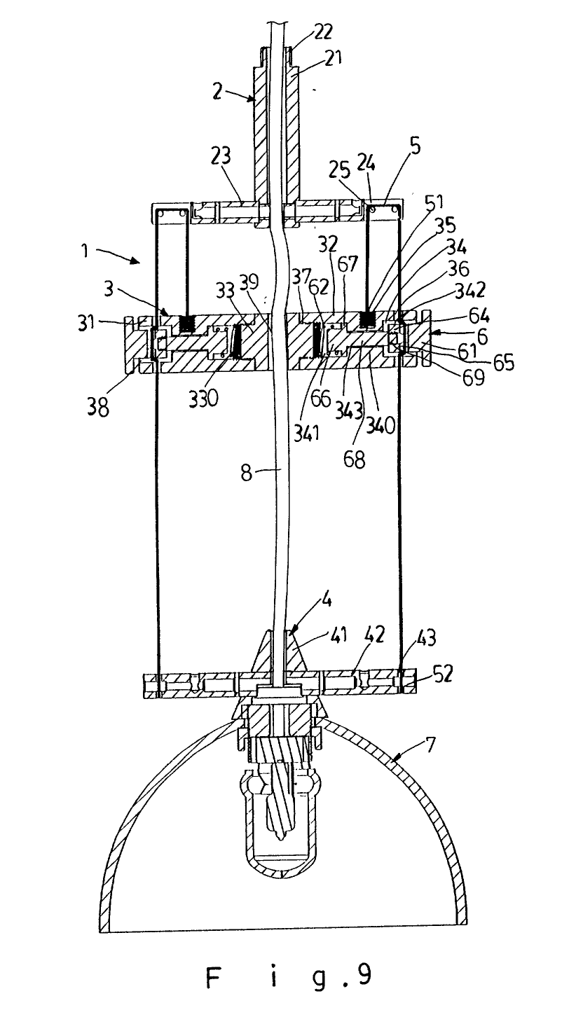

As for the counterweight unit 3, it is likewise consisted of two cylinders 31, 32 with a matching insulation unit 33, and inside the work chamber 34 of the cylinders 31, 32 is installed a locator 6, thereby to fasten in position and control the cord 5 running through the cylinders 31, 32 and the through hole 36, and on a side wall of the insulation unit 33 is at least a line placement hole 39, this line placement hole 39 is preferably aligned longitudinally (shown in FIG. 7), to enable insertion of the power wire 8 extending from the upper rack 2 for assembly, so that the power wire 8 will not interfere with the process for adjusting the lighting height position and the movement in adjusting the counterweight unit 3 (shown in FIGS. 8 and 9).

In such a structural design, the cord 5 and the upper and lower racks 2, 4 are completely without power source, meanwhile, like the aforementioned embodiment, single hand can be used for easy control of the locator 6 to fasten or loosen the cord 5, as well as pull and move the counterweight unit 3 to complete the adjustment of the lighting height position, meanwhile, by the fastening and positioning of the locator 6 we can obtain better positioning and stabilizing effects, so as to obtain selective assembly and increase the optional range of components with a larger load or heavier lighting fixtures even when in an imbalanced status of the counterweight unit 3 and the selection of lighting fixture 7 and lighting accessories, meanwhile by the use of different types of upper and lower racks 2, 4 and the counterweight unit 3, accompanied by assembly or replacement of various types of lighting fixtures or lighting accessories, to construct different types of linear suspension projector lamps for consumers' optional purchase.

Although the present invention has been illustrated and described with reference to the preferred embodiment thereof, it should be understood that it is in no way limited to the details of such embodiment but is capable of numerous modifications within the scope of the appended claims.

What is claimed is:

1. A linear suspension projector lamp assembly, comprising:
an upper rack, providing electrical connection with a power source, and a winding space for installing a cord;
at least one cord, winding on the winding space of the upper rack, with two cord ends respectively extending downward;
a lower rack, having an electrical box for assembly of selective types of lighting fixtures, on two sides of an arm rod being a tying hole to be fixed and tied by a second cord end;
a counterweight unit, installed between the upper and lower racks, having a tying hole to be tied by a first cord end of the cord, providing a through hole to correspond to a work chamber to be inserted for assembly by the second cord end, inside the cylinders being a work chamber space for assembling a locator;
by power supplied directly to all components for transmission, and control of the locator to fasten or loosen the cord, the control and operation can be completed single-handedly, and meanwhile driving the counterweight unit to move up or down, the cord synchronously pulling and driving the projector lamp assembly to move in a reverse direction to the counterweight unit, adjusting the lighting height position and obtain better positioning and stabilizing effects, for compatibility with a larger or heavier projector lamp, meanwhile by combination of various types of racks and counterweight or replacement of various types of lighting fixtures or lighting accessories, to constitute various types of linear suspension projector lamps for consumer's optional purchase.

2. The linear suspension projector lamp assembly of claim 1, wherein said upper rack comprises a longitudinally assembled extension rod, to an upper end can be assembled with various types of electrical connector to correspond a track or directly correspond to a power supply box for electrical connection, at another end of the extension rod being installed a lock assembly rod, on two sides of the rod being respectively provided a winding space for the cord to wind on the rack with a suspension fulcrum.

3. The linear suspension projector lamp assembly of claim 2, wherein said winding space on the upper rack at the lock shaft rod has a shaft post transverse installed vertically in the winding space, for the cord to wind onto the rack on a suspension fulcrum.

4. The linear suspension projector lamp assembly of claim 2, wherein said lock shaft rod and the extension rod on the upper rack formed an angle, this assembled angle can be varied according to design, preferably but not limited to a horizontal angle of the lock shaft rod.

5. The linear suspension projector lamp assembly of claim 4, wherein a shape and length of the lock shaft rod of the upper rack can be changed to suit various designs.

6. The linear suspension projector lamp assembly of claim 5, wherein said lock shaft rod of the upper rack is preferably made of conductive metal material, for electrical connection with a power source for direct transmission to the cord when applied to low-voltage projector lamp assembly.

7. The linear suspension projector lamp assembly of claim 1, wherein said cord for linear connection is preferably composed of two cords to obtain better symmetrical balance of suspension assembly and pulling.

8. The linear suspension projector lamp assembly of claim 7, wherein said cord is made of but not limited to conductive metal material, to obtain power source to be transmitted to the lower rack when applied to a low-voltage projector lamp assembly.

9. The linear suspension projector lamp assembly of claim 7, wherein said a diameter and length of the cord can be changed to suit design or requirements in use.

10. The linear suspension projector lamp assembly of claim 1, wherein there is an angle formed by the arm rods of the lower rack and the electrical box, this assembled angle can be changed to suit different designs, preferably but not limited to a horizontal angle from the extending arm rods.

11. The linear suspension projector lamp assembly of claim 10, wherein a shape and length of the arm rods of the lower rack can be changed to suit different requirements or designs.

12. The linear suspension projector lamp assembly of claim 10, wherein the arm rods of the lower rack are made of conductive metal materials, for electrical connection of the cord for transmission of power source into the projector lamp assembly when applied to a low-voltage projector lamp assembly.

13. The linear suspension projector lamp assembly of claim 10, wherein the electrical box of the lower rack can be made in different types and styles, different types and specifications of projector lamps being installed directly in the electrical box, or different types of lamp housing, reflective hood or other projector accessories can be replaced, assembled or not assembled, of course different types of lighting fixtures can be assembled or not assembled to suit designs or requirements, to constitute projector lamp assembly of a same configuration; this electrical box can also be directly be made integrally with the projector lamp assembly and lamp hood, to configure different styles of lighting fixture by assembling alternative lamp holder, reflective hood and other lighting accessories, and constitute different styles of projector lamp assembly.

14. The linear suspension projector lamp assembly of claim 1, wherein said counterweight unit is composed of two cylinders in combination with an insulation unit, a hollow space inside the cylinders matching a first and a second opening located at corresponding positions on the cylinders, to define a work chamber providing space for the assembly of the counterweight unit and its operation.

15. The linear suspension projector lamp assembly of claim 14, wherein said work chamber of the counterweight unit is separated by a partition, forming a flexibility chamber that is assembled with a side of the insulation unit, and a cord control chamber located on the outside to correspond the second opening, the flexibility chamber and the cord control chamber being joined by a channel on the partition to communicate with each other.

16. The linear suspension projector lamp assembly of claim 1, wherein said locator installed in the work chamber of the counterweight unit comprises a press member movable in the cord control chamber, this press member has an extension of a lock assembly nozzle with an inside thread, running axially on the end face of the lock assembly nozzle being a cord pulling hole, for insertion and assembly by the second cord end of the cord; a press key, one end formed with a press shaft wall, the press key having a connecting key extended from an end face of the press shaft wall, running through the channel on the wall under regular conditions, at an end of the connecting key being a thread inside the cord control chamber to correspond to the tightening by the lock assembly nozzle of the press member.

17. The linear suspension projector lamp assembly of claim 16, wherein said press member of the locator is regularly protruded out of the work chamber, installed at an interval from the second opening, serving as a space for the press member to operate and control the cord.

18. The linear suspension projector lamp assembly of claim 16, wherein said lock assembly nozzle extended from the press member of the locator has an outer diameter slightly smaller than an inner diameter of the cord control chamber, this diameter difference is preferably equivalent or no larger than the diameter of the cord being used, to provide positioning function to the cord for fastening purpose.

19. The linear suspension projector lamp assembly of claim 16, wherein said cord pulling hole on an end face of the lock assembly nozzle extended from the press member of the locator is located in a same longitudinal position as the through hole running through the cord control chamber, for sequential insertion and assembly by the cord, the cord pulling hole and the through hole being matching to each other when pressed in position in the cord control chamber, so the cord is in a loosened state, the press member at a regular position subjected to flexibility but not subjected to movement, the cord pulling hole and the through hole are assembled in a staggered way, enabling its fastening and cord into position.

20. The linear suspension projector lamp assembly of claim 16, wherein said press shaft wall formed by the press key of the locator has an outer diameter on the end face of the wall that is slightly larger than the inner diameter of the channel on the partition, forming a flexible check function causing the press key to be positioned in a regular position.

21. The present invention of linear suspension projector lamp assembly comprises:
an upper rack, with an extension rod running through a hollow for electrical connection with a power source, for downward extension of the power source wire in electrical connection, a lock shaft rod installed at an extension rod having a winding space for winding the cord;
at least a cord, winding on the winding space on the upper rack, having a first cord end and a second cord end that extend downward for winding and fastening of a pulling end;
a lower rack, having an electrical box for assembly of optionally styles and types of projector lamp assembly, on two sides of an arm rod extended from the electrical box being respectively tying holes for fastening and tying the second cord end of the cord, the projector lamp assembly being directly in electrical connection with the power source wire to supply required power;
a counterweight unit, consisting of two cylinders in combination with an insulation unit, installed between the upper and lower acks, the cylinders respectively having tying holes for tying the first cord end of the cord, and for insertion and assembly of the second cord end through the through hole in the cord control chamber, and in the cylinders being a work space that is assembled by a flexibility chamber and a cord control chamber that are partitioned by a partition but communicating with each other to assemble, to install the locator, on an end face of the insulation unit being at least a wire placement hole for insertion and assembly of the power cord wire;
at least one set of locator, the press member that is movable in the cord control chamber has an extension of a lock assembly nozzle with an inside thread, running axially on the end face of the lock assembly nozzle being a cord pulling hole for insertion and assembly by the second cord end of the cord; a press key, having one end with a formation of a press shaft wall, forming a pressing space with a side face of the insulation unit, having a flexibility member that is regularly pressing on the press key, the press key having a connecting key extending from an end face of the press shaft wall, and in regular condition running through the channel on the partition, at an end of the connecting key being a thread, inside the cord control chamber to correspond to the press member for tightening purpose with the lock assembly nozzle;
by direct electrical connection between the power source and the projector lamp assembly, it is applicable to a projector lamp assembly with non-low voltage specifications, the locator can be operated single-handedly to fasten or loosen the cord, meanwhile driving the counterweight unit to move up and down, and synchronously the cord pulling and driving the projector lamp assembly to move to a height in a reverse direction to the counterweight unit, to adjust a lighting height position and obtain better positioning and stabilizing effects, in combination with a larger or a heavier projector lamp assembly, meanwhile by assembling various types and styles of racks and counterweight, in combination with or in replacement of various types of lighting fixtures and lighting accessories, to compose various types of linear suspension projector lamps for consumer's optional purchase.

22. The linear suspension projector lamp assembly of claim 21, wherein said lock shaft rod, arm rod and cord of the lower rack can be made of conductive metal material or other nonconductive materials, without having to serve as a transmission medium of power when applied to higher-voltage project lamp assembly.
